(19) United States
(12) Patent Application Publication
(10) Pub. No.: US 2026/0110628 A1
(43) Pub. Date: Apr. 23, 2026

(54) Optical System for Optical Examination of a Test Sample

(71) Applicant: 3M INNOVATIVE PROPERTIES COMPANY, St. Paul, MN (US)

(72) Inventors: John A. Wheatley, Stillwater, MN (US); William J. Gray, Woodbury, MN (US); Bharat R. Acharya, Woodbury, MN (US); Aaron M. Marcella, White Bear Lake, MN (US)

(21) Appl. No.: 19/154,074

(22) PCT Filed: Feb. 12, 2024
(86) PCT No.: PCT/IB2024/051293

§ 371 Date: Aug. 6, 2025

Related U.S. Application Data
(60) Provisional application No. 63/485,581, filed on Feb. 17, 2023.

(51) Int. Cl. G01N 21/25; G01N 21/17; G01N 21/31

(52) U.S. Cl. CPC G01N 21/255; G01N 21/3103; G01N 2021/1748; G01N 2021/177; G01N 2201/0668

(57) ABSTRACT

An optical system includes a front optical film and a back reflector defining a light recycling optical cavity therebetween. The optical cavity is configured to receive a test sample. The optical system includes a light source disposed on the front optical film side of the optical cavity and configured to emit first and second lights having respective intensities I1b and I1g and respective first and second wavelengths toward the optical cavity, such that when the test sample is disposed in the recycling optical cavity and the emitted first and second lights are recycled in the optical cavity while being at least partially absorbed by the test sample, at least portions of the recycling emitted first and second lights exit the optical cavity through the front optical film as respective exiting first and second lights having respective optical intensities I2b and I2g. I2g/I1g is greater than I2b/I1b by at least 10%.

### TECHNICAL FIELD

The present description relates generally to optical systems that may be utilized for optically examining a test sample.

### BACKGROUND

An optical cavity can be defined between spaced apart reflectors.

### SUMMARY

In some aspects, the present description provides an optical system for an optical examination of a test sample having a higher first optical absorption at a first wavelength and a lower second optical absorption at a second wavelength. The optical system includes a front optical film and a back reflector defining a light recycling optical cavity therebetween. The optical cavity is configured to receive the test sample, such that for a substantially normally incident light, for at least one polarization state, and for at least one wavelength in a wavelength range extending from about 250 nm to about 1500 nm, the front optical film transmits at least 20% of the incident light and reflects at least 20% of the incident light, and the back reflector reflects at least 60% of the incident light. The optical system includes a light source disposed on the front optical film side of the optical cavity and configured to emit first and second lights having respective intensities I1b and I1g and the respective first and second wavelengths toward the optical cavity, such that when the test sample is disposed in the recycling optical cavity and the emitted first and second lights are recycled in the optical cavity while being at least partially absorbed by the test sample, at least portions of the recycling emitted first and second lights exit the optical cavity through the front optical film as respective exiting first and second lights at the respective first and second wavelengths having respective optical intensities I2b and I2g. I2g/I1g can be greater than I2b/I1b by at least 10%.

In some aspects, the present description provides an optical system including a front optical film and a back reflector defining a light recycling optical cavity therebetween. The optical cavity is configured to receive a test sample configured to convert at least a portion of an incident first light having a first wavelength and an intensity I1b to a converted second light having at least a second wavelength different from the first wavelength and an intensity I1g. The front optical film includes a plurality of layers numbering at least 4 in total where each of the layers has an average thickness of less than about 500 nm, such that for a substantially normally incident light and for at least one polarization state: for the first wavelength, the front optical film reflects at least 50% of the incident light for a first incident angle of less than about 20 degrees and transmits at least 50% of the incident light for a second incident angle of greater than about 30 degrees; for the second wavelength and each of the first and second incident angles, the front optical film transmits at least 50% of the incident light; and for each of the first and second wavelengths and each of the first and second incident angles, the back reflector reflects at least 60% of the incident light. The optical system includes a light source disposed on the front optical film side of the optical cavity and configured to emit an emitted first light having the first wavelength and the intensity I1b and toward the optical cavity. When the test sample is disposed in the recycling optical cavity and the emitted first light is recycled in the optical cavity while being at least partially absorbed by the test sample, at least a portion of the recycling emitted first light is converted by the test sample to a recycling second light that exits the optical cavity through the front optical film as an exiting second light having the second wavelength and an optical intensity I2g. I2g can be greater than I1g by at least 10%.

In some aspects, the present description provides an optical system including a front optical film and a back reflector defining a light recycling optical cavity therebetween; and a biological test sample disposed in the optical cavity and having a higher first optical absorption at a first wavelength and a lower second optical absorption at a second wavelength. For a substantially normally incident light, for at least one polarization state, and for at least one wavelength in a wavelength range extending from about 250 nm to about 1500 nm, the front optical film transmits at least 20% of the incident light and reflects at least 20% of the incident light, and the back reflector reflects at least 60% of the incident light, such that when a light source is disposed on the front optical film side of the optical cavity and emits first and second lights having respective intensities I1b and I1g and the respective first and second wavelengths toward the optical cavity with I1b and I1g being within 10% of one another, the emitted first and second lights are recycled in the optical cavity while being at least partially absorbed by the biological test sample, at least portions of the recycling emitted first and second lights exit the optical cavity through the front optical film as respective exiting first and second lights at the respective first and second wavelengths having respective optical intensities I2b and I2g. I2g/I1g can be greater than I2b/I1b by at least 10%.

In some aspects, the present description provides an optical system including a front optical film and a back reflector defining a light recycling optical cavity therebetween; and a biological test sample disposed in the optical cavity. The biological test sample is configured to convert at least a portion of an incident first light having a first wavelength and an intensity I1b to a converted second light having at least a second wavelength different from the first wavelength and an intensity I1g. Each of the first and second wavelengths is in a wavelength range extending from about 250 nm to about 1500 nm. The front optical film includes a plurality of layers numbering at least 4 in total where each of the layers can have an average thickness of less than about 500 nm, such that for a substantially normally incident light and for at least one polarization state: for the first wavelength, the front optical film reflects at least 50% of the incident light for a first incident angle of less than about 20 degrees and transmits at least 50% of the incident light for a second incident angle of greater than about 30 degrees; for the second wavelength and each of the first and second incident angles, the front optical film transmits at least 50% of the incident light; and for each of the first and second wavelengths and each of the first and second incident angles, the back reflector reflects at least 60% of the incident light. When a light source is disposed on the front optical film side of the optical cavity and emits an emitted first light having the first wavelength and the intensity I1b and toward the optical cavity so that the emitted first light is incident on the front optical film at the second incident angle, the emitted first light is recycled in the optical cavity while being at least partially absorbed by the biological test sample, and at least a portion of the recycling emitted first light is converted by the biological test sample to a recycling second light that exits the optical cavity through the front optical film as an exiting second light having the second wavelength and an optical intensity I2g. I2g can be greater than I1g by at least 10%.

These and other aspects will be apparent from the following detailed description. In no event, however, should this brief summary be construed to limit the claimable subject matter.

### BRIEF DESCRIPTION OF THE DRAWINGS

FIGS. 1-2 are schematic cross-sectional views of optical systems, according to some embodiments.

FIG. 3 is a schematic cross-sectional view of a mobile device, according to some embodiments.

FIGS. 4A-4C are schematic cross-sectional views of light substantially normally incident on a back reflector, a front optical film, and a test sample, respectively, according to some embodiments.

FIG. 5 is a schematic plot of optical absorption of a test sample versus wavelength, according to some embodiments.

FIG. 6 is a schematic cross-sectional view of an optical film, according to some embodiments.

FIG. 7 is a plot of transmittance and reflectance versus wavelength for an exemplary optical film, according to some embodiments.

FIG. 8 is a plot of normalized output power versus wavelength for various optical systems, according to some embodiments.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

Diagnostic enhancement systems have previously utilized bottom lit, top read architectures and often involve a backlight or light guide to introduce light into the system. According to some embodiments of the present description, an optical system utilizing a top lit, top read architecture is provided that may avoid utilizing a backlight and which can provide a simpler diagnostic system than conventional systems. The optical system can include an optical cavity defined between a front optical film and a back reflector. The front optical film can be a transflector through which light can be injected for an optical examination of a test sample disposed in the optical cavity. Light exiting the front optical film from the optical cavity can be detected to determine the presence of a material in the test sample, for example. The test sample can be a biological test sample such as an enzyme-linked immunoassay (ELISA) test sample, for example. The front optical film can be a metallic transflector or a polymeric multilayer optical film, for example. For a first wavelength, the multilayer optical film can be substantially reflective for a smaller first incident angle and substantially transmissive for a larger second incident angle. The optical system may include a light source configured to inject light having the first wavelength into the optical cavity at the second incident angle and a light detector configured to detect light having a second wavelength different from the first wavelength and exiting the optical cavity along a direction defined by the first incident angle.

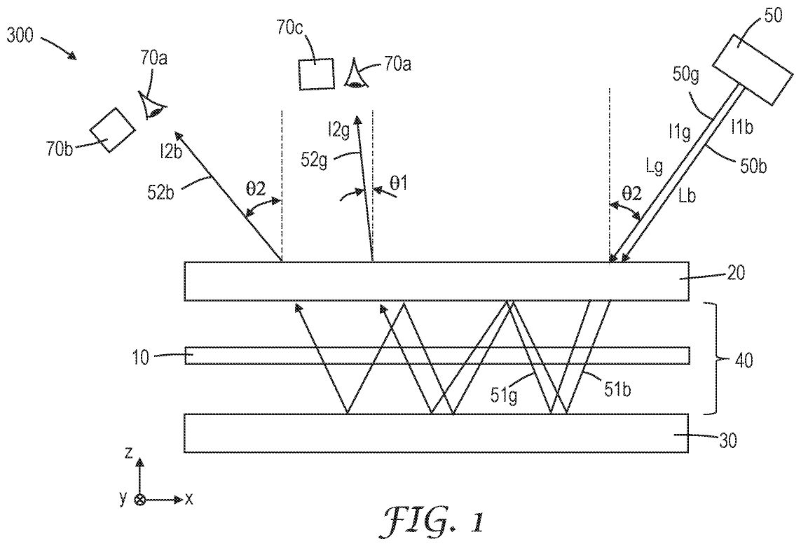

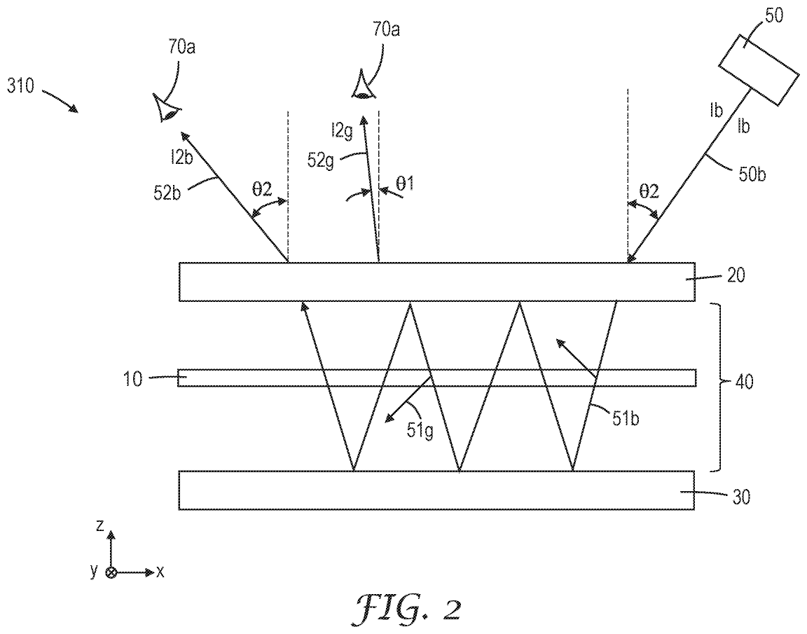

FIGS. 1-2 are schematic cross-sectional views of optical systems 300 and 310, respectively, according to some embodiments. The optical systems 300, 310 can be configured for an optical examination of a test sample 10. Optical system 300, 310 includes a front optical film 20 and a back reflector 30 defining a light recycling optical cavity 40 therebetween. The optical cavity 40 is configured to receive a test sample 10. The optical system 300, 310 can include a light source 50 and/or at least one detector 70b, 70c. An electrooptical device, which may be a mobile device such as a cell phone, may include the light source 50 and/or the at least one detector 70b, 70c. FIG. 3 is a schematic cross-sectional view of a mobile device 56, according to some embodiments. The mobile device 56 includes a lamp 53, which can correspond to the light source 50, and a camera 54, which can correspond to the at least one detector 70b, 70c. The mobile device 56 can be or include a cell phone, for example. The test sample 10 can be a biological test sample. The biological test sample can be or include an enzyme-linked immunosorbent assay (ELISA) test sample, for example. The front optical film 20, the back reflector 30 and the (e.g., biological) test sample 10 can define an optical system (e.g., a subsystem of the optical system 300, 310) and/or an optical stack.

The optical system 300, 310 can include a light source 50 disposed on the front optical film side of the optical cavity and configured to emit first and second lights 50b and 50g (see, e.g., FIG. 1) having respective intensities I1b and I1g and respective first and second wavelengths Lb and Lg toward the optical cavity, such that when the test sample 10 is disposed in the recycling optical cavity 40 and the emitted first and second lights are recycled (recycled light 51b, 51g) in the optical cavity 40 while being at least partially absorbed by the test sample 10, at least portions of the recycling emitted first and second lights exit the optical cavity through the front optical film 20 as respective exiting first and second lights 52b and 52g at the respective first and second wavelengths having respective optical intensities I2b and I2g, where I2g/I1g can be greater than I2b/I1b by at least 10%, 15%, 20%, 25%, or 30%. For example, I2b/I1b can be reduced by absorption of light having the first wavelength Lb by the test sample 10. In some embodiments, the light source 50 is configured to emit substantially collimated (e.g., having a divergence/convergence angle less than 30, 20, or 10 degrees) light for at least each of the first and second wavelengths toward the optical cavity. In some embodiments, I1b and I1g are within about 50, 40, 30, 20, 10, or 5 percent of one another. In some embodiments, the light source 50 comprises a lamp 53 of a mobile device 56 (see, e.g., FIG. 3).

The first and second wavelengths can differ by at least about 10, 20, or 30 nm, for example. In some embodiments, the first wavelength Lb is in a range of about 250 nm to about 600 nm, or about 300 nm to about 500 nm, for example. In some embodiments, the first wavelength Lb is a blue wavelength in a range of about 400 nm to about 480 nm or about 420 nm to about 460 nm, for example. In some embodiments, the second wavelength Lg is a green wavelength in a range of about 500 nm to about 600 nm or about 520 nm to about 580 nm, for example.

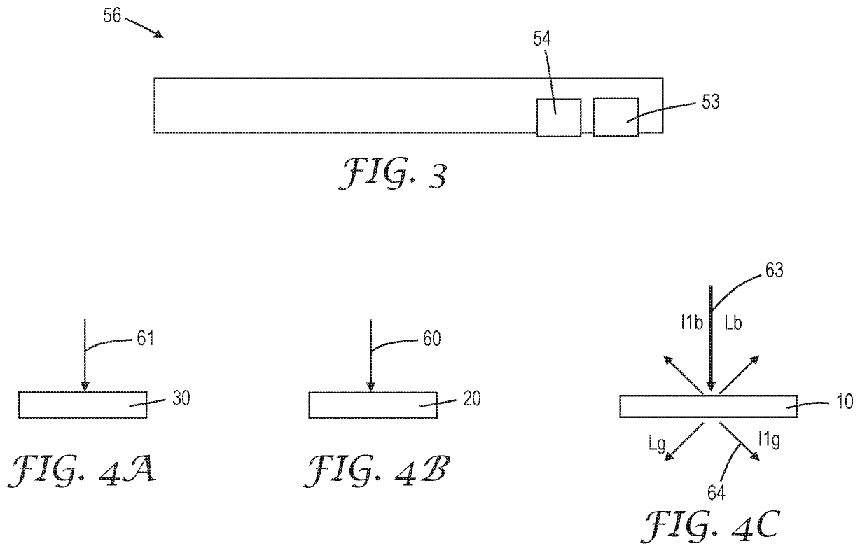

The light source 50 may alternatively be configured to emit light 50b, but not light 50g, when the test sample that is desired to be tested converts at least a portion of received light to an emitted light having a different wavelength, for example. In some embodiments, the light source 50 is disposed on the front optical film side of the optical cavity 40 and is configured to emit an emitted first light 50b having the first wavelength Lb and the intensity I1b and toward the optical cavity 40. In some embodiments, the test sample 10 is configured to convert at least a portion of an incident first light 63 having a first wavelength Lb and an intensity I1b to a converted second light 64 having at least a second wavelength Lg different from the first wavelength and an intensity I1g (see, e.g., FIG. 4C). In some embodiments, when the test sample is disposed in the recycling optical cavity and the emitted first light is recycled (recycled light 51b) in the optical cavity 40 while being at least partially absorbed by the test sample 10, at least a portion of the recycling emitted first light is converted by the test sample 10 to a recycling second light 51g that exits the optical cavity through the front optical film 20 as an exiting second light 52g having the second wavelength and an optical intensity I2g (see, e.g., FIG. 2). I2g can be greater than I1g by at least 10%, 15%, 20%, 25%, or 30%. For example, the intensity of light having the second wavelength in the optical cavity can be enhanced due to constructive interference in the optical cavity of light reflected from the front optical film 20 and the back reflector 30 and this can result in an increase in I2g compared to I1g.

In some embodiments, the optical system 300, 310 includes a sensor 70c configured to detect the exiting second light 52g and/or includes a sensor 70b configured to detect the exiting first light 52b. In some embodiments, the exiting first and second lights 52b and 52g are detected by at least one sensor 70a, 70b, 70c (see, e.g., FIG. 1). In some embodiments, the at least one sensor comprises an eye 70a of a viewer (see, e.g., FIGS. 1-2). For example, the optical system 300, 310 may be configured such that the exiting first and second lights 52b and 52g can be detected by inspection without the need of an electronic detector. In some embodiments, the at least one sensor comprises at least one electronic detector 70b, 70c. In some embodiments, the optical system 300, 310 comprises the at least one electronic detector 70b, 70c. In some embodiments, the at least one electronic detector comprises first and second electronic detectors 70b and 70c configured to detect the respective exiting first and second lights 52b and 52g. Useful light sources and detectors include those described in U.S. Pat. Appl. Publ. Nos. 2015/0131948 (Selli et al.); 2014/0211822 (Fattal et al.); and 2005/0019973 (Chua), for example. In some embodiments, the at least one electronic detector 70b, 70c comprises one or an array of a photodiode, a charged coupled device (CCD), a charge injection device (CID), a photodiode, an organic photodiode, a complementary metal-oxide-semiconductor (CMOS), and a thin-film transistor (TFT). In some embodiments, the at least one electronic detector 70b, 70c comprises a camera 54 of a mobile device 56 (see, e.g., FIG. 3).

In some embodiments, the detector 70c is disposed to detect light exiting the optical cavity 40 along a direction making an angle θ1 with a normal to the from optical film 20 of less than about 20, or 15, or 10, or 5 degrees. In some embodiments, the light source 50 is disposed so that the incident light 50b and/or 50g defines an incident angle θ2 greater than about 30, 35, or 40, or 45 degrees. In some embodiments, the detector 70b is disposed to detect light exiting the optical cavity 40 along a direction making the angle θ2 with a normal to the from optical film 20.

FIGS. 4A-4C are schematic cross-sectional views of light 61, 60, and 63 substantially normally (e.g., within 30, 20, 10, or 5 degrees of normal) incident on the back reflector 30, the front optical film 20, and the test sample 10, respectively, according to some embodiments. The front optical film 20, the back reflector 30, and/or the test sample 10 can have optical properties (e.g., transmittance and/or reflectance and or absorbance for substantially normally incident light 61, 60, 63) described elsewhere herein.

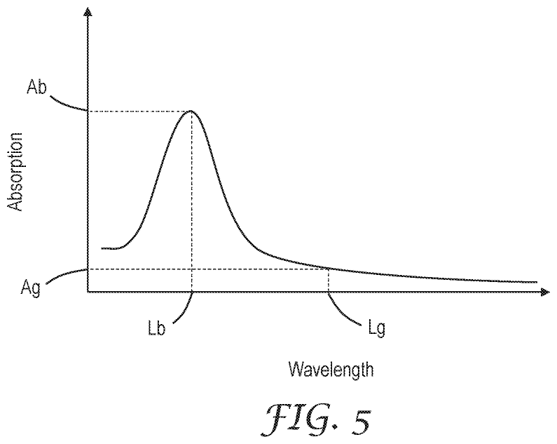

FIG. 5 is a schematic plot of optical absorption of a test sample 10 versus wavelength, according to some embodiments. The optical absorption can be for substantially normally incident light 63. In some embodiments, the optical system 300, 310 is configured for an optical examination of a test sample 10 having different optical absorptions at different wavelengths. In some embodiments, the test sample 10 has a higher first optical absorption Ab at a first wavelength Lb and a lower second optical absorption Ag at a second wavelength Lg. In some embodiments, Ab/Ag is greater than about 1.5, 2, 3, 5, 7, or 10, for example. The optical absorption can have a peak at a blue wavelength (e.g., Lb and/or about 450 nm). In some embodiments, the test sample 10 comprises one or more of phosphor, fluorescent dye, and quantum dots. In some embodiments, the test sample 10 is a biological test sample comprising a chromogenic substrate such as 3,3′,5,5′-tetramethylbenzidine (TMB).

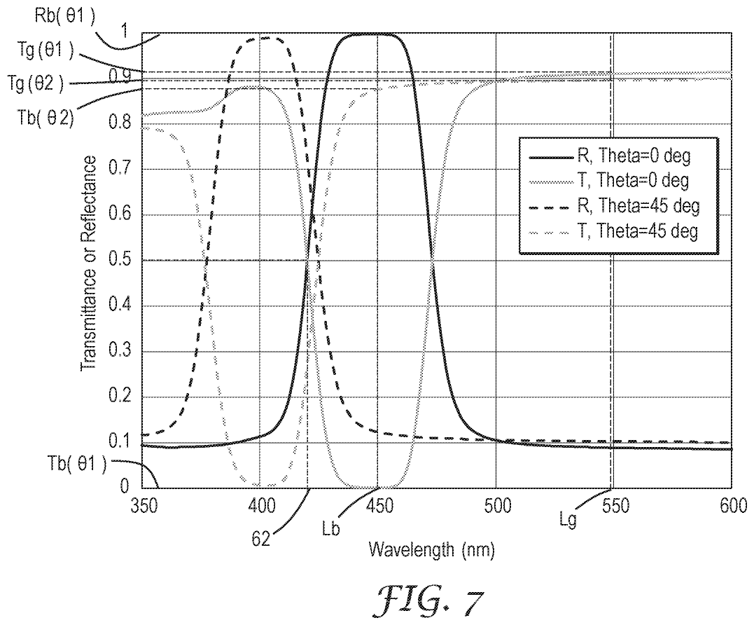

The front optical film 20 can be partially reflective and partially transmissive for at least one wavelength. In some embodiments, the front optical film 20 is or includes a metal. For example, the front optical film 20 can be a metallic transflector (e.g., a half silvered mirror). In some embodiments, the front optical film 20 is or includes a multilayer (e.g., polymeric) optical film. The multilayer optical film can have a reflection band that shifts with incident angle such that the wavelength Lb is substantially reflected at substantially normal incidence but not at an incident angle of about 45 degrees (see, e.g., FIG. 7), for example. In some embodiments, the back reflector 30 is or includes a metal. For example, the back reflector 30 can be a metallic reflector. In some embodiments, the back reflector 30 is or includes a multilayer (e.g., polymeric) optical film. The back reflector can include a broadband mirror film such as those available from 3M Company under the tradename ESR. Suitable metals for the front optical film 20 and/or the back reflector 30 include silver, aluminum, steel, or other suitably reflective metals or metal alloys. Metal for the front optical film 20 can be suitably thin to give a desired transmittance. Metal for the back reflector can be suitably thick give a desired reflectance.

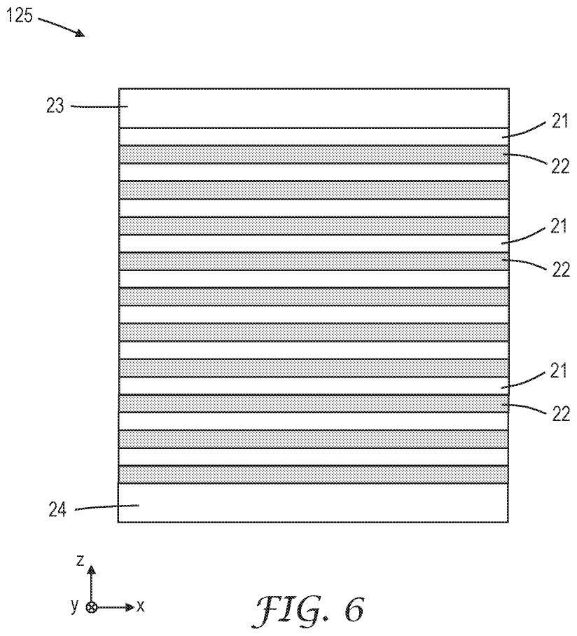

FIG. 6 is a schematic cross-sectional view of a multilayer optical film 125, according to some embodiments. As is known in the art, multilayer optical films including alternating polymeric layers can be used to provide desired reflection and transmission in desired wavelength ranges by suitable selection of layer thicknesses and refractive index differences. Multilayer optical films and methods of making multilayer optical films are described in U.S. Pat. No. 5,882,774 (Jonza et al.); U.S. Pat. No. 6,783,349 (Neavin et al.); U.S. Pat. No. 6,949,212 (Merrill et al.); U.S. Pat. No. 6,967,778 (Wheatley et al.); and U.S. Pat. No. 9,162,406 (Neavin et al.), for example. The multilayer optical film 125 may correspond to the front optical film 20 and/or to the back reflector 30. In some embodiments, the front optical film 20 and/or the back reflector 30 includes a plurality of layers 21, 22 numbering at least 4 in total where each of the layers has an average thickness of less than about 500 nm. The plurality of layers 21, 22 can number at least 10, 25, 50, or 100 in total, for example. The plurality of layers 21, 22 can number up to 1500, 1200, 1000, 800, 600, or 400, for example. Each of the layers 21, 22 can have an average thickness of less than about 450, 400, 350, 300, 250, or 200 nm. The average thickness for each of the layers 21, 22 can be at least about 10, 25, or 50 nm, for example. In some embodiments, the front optical film 20 includes a plurality of layers 21, 22 and the back reflector 30 includes a plurality of second layers 21, 22. The front optical film 20 and/or the back reflector 30 can further include at least one skin layer 23, 24 having an average thickness of greater than about 500, 600, 700, 800, 900, 1000, 1500, or 2000 nm. The skin layer(s) can have an average thickness up to about 20, 15, or 10 microns, for example.

FIG. 7 is a plot of transmittance (T) and reflectance (R) versus wavelength for an exemplary optical film for normal incidence (Theta=0 degrees) and an incident angle of 45 degrees (Theta=45 degrees), according to some embodiments. The optical film having the spectrum of FIG. 7 can be a multilayer optical film and can correspond to the front optical film 20. The multilayer optical film can include alternating first and second layers having a thickness profile chosen to produce the reflection bands shown in FIG. 7, as would be appreciated by those of ordinary skill in the art. The first and second layers can comprise, for example, polyethylene terephthalate (PET) and co-polymethylmethacrylate (coPMMA), respectively, or other polymers described in the multilayer optical film references provided elsewhere herein.

In some embodiments, for a substantially normally incident light 60, 61, for at least one polarization state (e.g., polarized along the x-axis or the y-axis, referring to the x-y-z coordinate system of FIG. 6, for example), and for at least one wavelength 62 in a wavelength range extending from about 250 nm to about 1500 nm, the front optical film 20 transmits at least 20% of the incident light and reflects at least 20% of the incident light, and the back reflector reflects at least 60%, or 70%, or 80%, or 90%, or 95% of the incident light. The front optical film 20 can transmit at least 25%, 30%, 35%, 40%, 45%, or 50% of the incident light. The front optical film 20 can reflect at least 25%, 30%, 35%, 40%, 45%, or 50% of the incident light. For example, the front optical film 20 can transmit at least 30% of the incident light and reflect at least 30% of the incident light, or can transmit at least 40% of the incident light and reflect at least 40% of the incident light. The at least one polarization state can include orthogonal first and second polarization states (e.g., mirror or partial mirror) or can include a single polarization state (e.g., reflective polarizer). The at least one at least one wavelength 62 can be at least about 250, 300, or 350 nm, for example. The at least one at least one wavelength 62 can be up to about 1500, 1200, 1000, 800, or 600 nm, for example.

In some embodiments, for a substantially normally incident light 60, 61 and for at least one polarization state: for the first wavelength Lb, the front optical film 20 reflects [Rb(θ1) which can be about 100%-Tb(θ1)] at least 50% of the incident light for a first incident angle (e.g., corresponding to θ1 depicted in FIGS. 1-2) of less than about 20 degrees and transmits [Tb(θ2)] at least 50% of the incident light for a second incident angle (e.g., corresponding to θ2 depicted in FIGS. 1-2) of greater than about 30 degrees; and for the second wavelength Lg and each of the first and second incident angles, the front optical film transmits [Tg(θ1), Tg(θ2)] at least 50%, or 55%, or 60%, or 65%, or 70%, or 75%, or 80%, or 85%, or 90% of the incident light. The first incident angle can be less than about 5, or 10, or 5 degrees. The second incident angle can be greater than about 35, or 40, or 45 degrees. In some embodiments, for the substantially normally incident light, for the at least one polarization state, and for the first wavelength Lb, the front optical film 20 reflects at least 55%, 60%, 65%, 70%, 75%, 80%, 85%, 90% of the incident light for the first incident angle. In some embodiments, for the substantially normally incident light, for the at least one polarization state, and for the first wavelength Lb, the front optical film 20 transmits at least 55%, 60%, 65%, 70%, 75%, 80%, 85%, 90% of the incident light for the second incident angle. In some embodiments, for the substantially normally incident light, for the at least one polarization state, and for the second wavelength Lg and each of the first and second incident angles, the front optical film transmits at least 55%, 60%, 65%, 70%, 75%, 80%, 85%, 90% of the incident light. In some embodiments, for the substantially normally incident light 60, 61, for the at least one polarization state, and for each of the first and second wavelengths and each of the first and second incident angles, the back reflector reflects at least 60%, 70%, 80%, 90%, or 95% of the incident light.

### EXAMPLES

Systems as generally shown in FIGS. 1-2 were modeled. Model Setup A utilized a non-absorbing transflector as the front optical film 20 which was 50% reflective and 50% transmissive. Setup B utilized an absorbing transflector with 50% reflection, 20% absorption, and 30% transmission. Setups C and D utilized the multilayer optical film (MOF) having the spectrum of FIG. 7 as the front optical film. In Setups A-C, the light was normally incident on the front optical film 20. In Setup D, the light was incident on the MOF at an incident angle of about 45 degrees. In each Setup, exiting light was detected along a direction substantially normal to the front optical film 20 (e.g., detected by detector 70c depicted in FIG. 1). In each case, the back reflector 30 was modeled as a Lambertian reflector having a 100% reflectance. The test sample was modeled as 3,3′,5,5′-tetramethylbenzidine (TMB) which has an absorption peak at a wavelength of about 450 nm. The spectrum of detected light was normalized by averaging the spectrum between 580 nm and 780 nm and normalizing this to unity. This wavelength range was chosen because the absorption of TMB is low here so that the detected light in this ranged represented the background signal. Any deviation from this signal from 400 nm to 500 nm represented absorption from the test sample. Deviations below 400 nm were due to both the lower input from the source and from absorption.

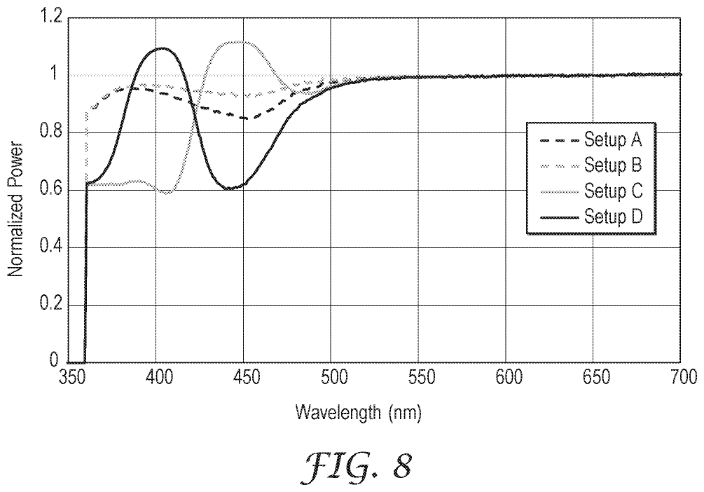

FIG. 8 is a plot of normalized output power versus wavelength for various modeled systems. Setup A showed a 15% dip in signal at 450 nm where TMB has an absorption peak while Setup B showed a 7% dip at 450 nm. For Setup C, where the light was normally incident on the MOF, an increase in power was seen between 420 and 450 nm which is the expected behavior as the MOF was designed to reflect in this band for normally incident light. For Setup D where the light was obliquely incident on the MOF, a roughly 40% dip in signal was observed at 450 nm, indicating that Setup D provided an efficient recycling cavity for detecting absorbing material of the test sample 10.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially” with reference to a property or characteristic is not otherwise clear to one of ordinary skill in the art in the context in which it is used and described in the present description and when it would be clear to one of ordinary skill in the art what is meant by an opposite of that property or characteristic, the term “substantially” will be understood to mean that the property or characteristic is exhibited to a greater extent than the opposite of that property or characteristic is exhibited.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations, or variations, or combinations of the specific embodiments discussed herein. Therefore, it is intended that this disclosure be limited only by the claims and the equivalents thereof.

What is claimed is:

1. An optical system for an optical examination of a test sample having a higher first optical absorption at a first wavelength and a lower second optical absorption at a second wavelength, the optical system comprising:
a front optical film and a back reflector defining a light recycling optical cavity therebetween, the optical cavity configured to receive the test sample, such that for a substantially normally incident light, for at least one polarization state, and for at least one wavelength in a wavelength range extending from about 250 nm to about 1500 nm, the front optical film transmits at least 20% of the incident light and reflects at least 20% of the incident light, and the back reflector reflects at least 60% of the incident light; and
a light source disposed on the front optical film side of the optical cavity and configured to emit first and second lights having respective intensities I1b and I1g and the respective first and second wavelengths toward the optical cavity,
such that when the test sample is disposed in the recycling optical cavity and the emitted first and second lights are recycled in the optical cavity while being at least partially absorbed by the test sample, at least portions of the recycling emitted first and second lights exit the optical cavity through the front optical film as respective exiting first and second lights at the respective first and second wavelengths having respective optical intensities I2b and I2g, I2g/I1g greater than I2b/I1b by at least 10%.

2. The optical system of claim 1, wherein the front optical film comprises a metal.

3. The optical system of claim 1, wherein the front optical film comprises a plurality of layers numbering at least 4 in total, each of the layers having an average thickness of less than about 500 nm, such that for a substantially normally incident light and for at least one polarization state:
for the first wavelength, the front optical film reflects at least 50% of the incident light for a first incident angle of less than about 20 degrees and transmits at least 50% of the incident light for a second incident angle of greater than about 30 degrees; and
for the second wavelength and each of the first and second incident angles, the front optical film transmits at least 50% of the incident light.

4. The optical system of claim 3, wherein the light source is configured to emit substantially collimated light for at least each of the first and second wavelengths toward the optical cavity.

5. The optical system of claim 1, wherein the light source comprises a lamp of a mobile device.

6. The optical system of claim 1, wherein the exiting first and second lights are detected by at least one sensor.

7. The optical system of claim 6, wherein the at least one sensor comprises at least one electronic detector.

8. The optical system of claim 7, wherein the at least one electronic detector comprises first and second electronic detectors configured to detect the respective exiting first and second lights.

9. The optical system of claim 7, wherein the at least one electronic detector comprises a camera of a mobile device.

10. An optical system comprising:
a front optical film and a back reflector defining a light recycling optical cavity therebetween, the optical cavity configured to receive a test sample configured to convert at least a portion of an incident first light having a first wavelength and an intensity I1b to a converted second light having at least a second wavelength different from the first wavelength and an intensity I1g, the front optical film comprising a plurality of layers numbering at least 4 in total, each of the layers having an average thickness of less than about 500 nm, such that for a substantially normally incident light and for at least one polarization state:
for the first wavelength, the front optical film reflects at least 50% of the incident light for a first incident angle of less than about 20 degrees and transmits at least 50% of the incident light for a second incident angle of greater than about 30 degrees;
for the second wavelength and each of the first and second incident angles, the front optical film transmits at least 50% of the incident light; and
for each of the first and second wavelengths and each of the first and second incident angles, the back reflector reflects at least 60% of the incident light; and
a light source disposed on the front optical film side of the optical cavity and configured to emit an emitted first light having the first wavelength and the intensity I1b and toward the optical cavity, wherein, when the test sample is disposed in the recycling optical cavity and the emitted first light is recycled in the optical cavity while being at least partially absorbed by the test sample, at least a portion of the recycling emitted first light is converted by the test sample to a recycling second light that exits the optical cavity through the front optical film as an exiting second light having the second wavelength and an optical intensity I2g, I2g greater than I1g by at least 10%.

11. The optical system of claim 10, wherein the back reflector comprises a metal.

12. The optical system of claim 10, wherein the back reflector comprises a plurality of second layers numbering at least 4 in total, each of the second layers having an average thickness of less than about 500 nm.

13. The optical system of claim 10 further comprising a sensor configured to detect the exiting second light.

14. An optical system comprising:
a front optical film and a back reflector defining a light recycling optical cavity therebetween; and
a biological test sample disposed in the optical cavity and having a higher first optical absorption at a first wavelength and a lower second optical absorption at a second wavelength, wherein for a substantially normally incident light, for at least one polarization state, and for at least one wavelength in a wavelength range extending from about 250 nm to about 1500 nm, the front optical film transmits at least 20% of the incident light and reflects at least 20% of the incident light, and the back reflector reflects at least 60% of the incident light, such that when a light source is disposed on the front optical film side of the optical cavity and emits first and second lights having respective intensities I1b and I1g and the respective first and second wavelengths toward the optical cavity, I1b and I1g being within 10% of one another, the emitted first and second lights are recycled in the optical cavity while being at least partially absorbed by the biological test sample, at least portions of the recycling emitted first and second lights exit the optical cavity through the front optical film as respective exiting first and second lights at the respective first and second wavelengths having respective optical intensities I2b and I2g, I2g/I1g greater than I2b/I1b by at least 10%.

15. An optical system comprising:
a front optical film and a back reflector defining a light recycling optical cavity therebetween; and
a biological test sample disposed in the optical cavity, the biological test sample configured to convert at least a portion of an incident first light having a first wavelength and an intensity I1b to a converted second light having at least a second wavelength different from the first wavelength and an intensity I1g, each of the first and second wavelengths being in a wavelength range extending from about 250 nm to about 1500 nm, the front optical film comprising a plurality of layers numbering at least 4 in total, each of the layers having an average thickness of less than about 500 nm, such that for a substantially normally incident light and for at least one polarization state:
for the first wavelength, the front optical film reflects at least 50% of the incident light for a first incident angle of less than about 20 degrees and transmits at least 50% of the incident light for a second incident angle of greater than about 30 degrees;
for the second wavelength and each of the first and second incident angles, the front optical film transmits at least 50% of the incident light; and
for each of the first and second wavelengths and each of the first and second incident angles, the back reflector reflects at least 60% of the incident light,
wherein, when a light source is disposed on the front optical film side of the optical cavity and emits an emitted first light having the first wavelength and the intensity I1b and toward the optical cavity so that the emitted first light is incident on the front optical film at the second incident angle, the emitted first light is recycled in the optical cavity while being at least partially absorbed by the biological test sample, and at least a portion of the recycling emitted first light is converted by the biological test sample to a recycling second light that exits the optical cavity through the front optical film as an exiting second light having the second wavelength and an optical intensity I2g, I2g greater than I1g by at least 10%.
